(19) United States
(12) Patent Application Publication
(10) Pub. No.: US 2022/0083386 A1
(43) Pub. Date: Mar. 17, 2022

(54) METHOD AND SYSTEM FOR NEURAL NETWORK EXECUTION DISTRIBUTION

(71) Applicant: SAMSUNG ELECTRONICS CO., LTD., Suwon-si, Gyeonggi-do (KR)

(72) Inventors: Mario ALMEIDA, Middlesex (GB); Stefanos LASKARIDIS, Middlesex (GB); Stylianos VENIERIS, Middlesex (GB); Ilias LEONTIADIS, Middlesex (GB)

(21) Appl. No.: 17/420,259

(22) PCT Filed: Apr. 10, 2020
(86) PCT No.: PCT/KR2020/004867

§ 371 Date: Jul. 1, 2021

(30) Foreign Application Priority Data
Nov. 12, 2019 (GR) 20190100509
Jan. 22, 2020 (GB) 2000922.1

(51) Int. Cl. G06F 9/50; G06N 3/10

(52) U.S. Cl. CPC G06F 9/5038; G06F 2209/509; G06N 3/10; G06F 9/505

(57) ABSTRACT

Broadly speaking, the present techniques relate to methods and systems for dynamically distributing the execution of a neural network across multiple computing resources in order to satisfy various criteria associated with implementing the neural network. For example, the distribution may be performed to spread the processing load across multiple device, which may enable the neural network computation to be performed quicker than if performed by a single device and more cost-effectively than if the computation was performed entirely by a cloud server.

### TECHNICAL FIELD

The present application generally relates to a method and system for distributing the execution of a neural network, and in particular to methods for identifying suitable computing resources to which to distribute the execution of part of a neural network.

### BACKGROUND ART

Generally speaking, neural networks, artificial intelligence systems and machine learning models are usually implemented or executed using a single computing resource. There is a growing desire for consumer electronic devices, such as smartphones or connected devices (e.g. Internet of Things devices) to be able to implement neural networks in order to enhance the user experience.

### DISCLOSURE OF INVENTION

### Technical Problem

However, on-device execution of a neural network may not always be possible, because of the processing capability of the device. Alternatively, a neural network could be executed using cloud computing or edge computing, and the results could be provided to the user device. This is useful when the user device is unable to execute the neural network, but may be disadvantageous from a cost-perspective—cloud/edge-based neural network execution is generally expensive.

The present applicant has recognised the need for an improved technique for executing a neural network.

### Solution to Problem

In a first approach of the present techniques, there is provided a method for distributing neural network execution using an electronic user device, the method comprising: receiving instructions to execute a neural network; obtaining at least one optimisation constraint to be satisfied when executing the neural network; identifying a number of computing resources available to the user device, and a load of each computing resource; determining a subset of the identified computing resources that are able to satisfy the at least one optimisation constraint; partitioning the neural network into a number of partitions based on the determined subset of computing resources that are able to satisfy the at least one optimisation constraint; assigning each partition of the neural network to be executed by one of the determined subset of computing resources; and scheduling the execution of the partitions of the neural network by each computing resource assigned to execute a partition. Where multiple optimisation constraints exist, the present techniques may identify computing resources that are able to satisfy all of the optimisation constraints.

In other words, the present techniques provide a method for distributing the execution of a neural network across multiple computing resources, which may enable the neural network to be executed using less energy. Advantageously, the present techniques may optimise performance of the neural network by using computing resources that have both the required processing capability and a low computer load at the time when the neural network (or a portion of the neural network) is to be executed. Furthermore, by distributing the execution across multiple computing resources, the neural network may be implemented in a more cost-effective manner, as cloud computing may not be needed as often or to execute as much of the neural network.

The present techniques may distribute the execution of the neural network that is to be executed entirely in a user device between the user device and at least one computing resource in the same network as the user device (e.g. in a home, vehicle or office environment), and/or between the user device and at least one computing resource at the edge of the network containing the user device, and/or between the user device and at least one computing resource in the cloud/a cloud server. It will be understood that the computing resources could be based anywhere, and that multiple computing resources of different types or in different locations could be used. Thus, deep learning inference computation can be dynamically scattered from a user device to local or remote computing resources.

The step of obtaining at least one optimisation constraint may comprise obtaining one or more of: a time constraint (e.g. the neural network must take no longer than 1 ms to execute/output a result), a cost constraint (e.g. a fixed cost value, or specified in terms of how long a cloud server can be used for per device), inference throughput, data transfer size (e.g. the number of Mbytes or Gbytes of data that need to transferred to other computing resources to implement the neural network), an energy constraint, and neural network accuracy (e.g. must always be 100%, or an accuracy of at least 80% is required). The constraints may be considered hard constraints or soft constraints/soft optimisation targets. For example, the time constraint may be a hard constraint, while the cost constraint may be a soft constraint.

The optimisation constraint may be specified by a service level agreement or a particular neural network or application area. Where multiple optimisation constraints are obtained, the optimisation constraints may be ranked or prioritised. For example, a time constraint may be ranked as more important when determining how to execute the neural network than neural network accuracy.

The time criterion may be an inference latency. For example, the time criterion may specify that the inference latency is less than 100 ms.

The cost criterion may comprise one or both of: a cost of implementing the neural network on the electronic user device, and a cost of implementing the neural network on a cloud server. The term “implementing the neural network” is used interchangeably herein with the terms “executing the neural network” or “running the neural network”. That is, the term “implementing” is used herein to mean executing or running. Thus, the cost of implementing the neural network is the cost to execute the NN. The cost criterion may specify the maximum number of times (or number of seconds/minutes) per day, week or year that a user device can use a cloud server to implement part of a neural network. Thus, the cost criterion may specify how often the cloud server may be used and indirectly specify a cost or maximum cost requirement. The cost criterion may be per client or per NN to be executed. The cost criterion may in some cases be a hard constraint, e.g. when the cost criterion is an amount of time or quota. In some cases, the cost criterion may be a soft constraint, e.g. “execute as much as possible on the user device”.

As mentioned above, the step of obtaining at least one criterion may comprise obtaining the at least one criterion from a service-level agreement (SLA) associated with executing the neural network.

The present techniques may split a network in multiple arbitrary partitions and assign those into different instances to be run. A deep neural network (DNN) may be represented by a Directed Acyclic Graph (DAG), called a dependency or execution graph of a network. Such a graph can be represented as G=(V, E), where V is the set of modules and E represents the data dependencies. Despite the various branches and skip connections in modern DNN architectures, their computation can be run sequentially or in parallel. The size of the tensors manipulated by DNN layers can vary greatly with many reaching several hundred kilobytes. Transferring one or more of these tensors can quickly outweigh the benefits of distributing the execution of the DNN, particularly under poor network conditions.

To overcome this, the present techniques may apply varying levels of lossless and/or lossy compression techniques to the data. When lossy compression is applied, the present techniques may take advantage of the nature of the data that is needed to be transferred to the other computing resources. (e.g. intermediate layer outputs) to reduce the data down to a point where the neural network's accuracy is not compromised by the compression.

Thus, the method may further comprise identifying a communication channel type for transferring data to each computing resource assigned to execute a partition; and determining whether communication channel based optimisation is required to transfer data to each computing resource for executing the partition. In other words, the method may identify what sort of communication protocol or channel (e.g. WiFi, Bluetooth, Thread, IPv6 over Low Power Wireless Standard (6LoWPAN), ZigBee, etc.) is used to communicate or send data between the user device and each computing resource, and use this information to determine if any data transfer optimisation process is required to transfer data to the computing resource for executing the neural network.

When communication channel based optimisation is required for a computing resource, the method may further comprise: compressing data to be transferred to the computing resource prior to transmitting the data to the computing resource for executing the partition, and/or quantising data to be transferred to the computing resource prior to transmitting the data to the computing resource for executing the partition.

In some cases, the method may comprise using any one or more of the following techniques: tensor quantisation, bit shuffling, and compression.

Tensor quantisation is frequently used in DNNs to reduce the model size and speed-up its operation. Linear quantisation may be performed on the intermediate activations that have to be transferred between the partitions. For example, 32 bit floats may be reduced into lower bit width representations such as 4 bits. In some cases, only the transferred tensors are quantized, and the weights and remaining activations of the model operate at their original bit width (e.g. 32 bits). Tensor quantisation may also be used in cases when lossless compression is used.

Bit shuffling comprises transposing the matrix such that all the least-significant-bits are in the same row. This data rearranging may allow the elimination of the computationally expensive Huffman coding in favour of a faster lossless data compression technique (such as LZ77 or LZ4).

Compression may comprise applying a fast lossless compression algorithm. When combined with tensor quantisation and bit shuffling, a significant reduction in data entropy may result, such that the resulting data size may be 60 times smaller than the size of the original tensors.

When the compressed data is sent to a computing resource for processing/execution, the computing resource reverses the techniques used to compress the data so that the data is returned to its original bit width before being used in the neural network.

The amount of compression applied by the present techniques is configurable. If the network conditions are good enough to meet a time criterion, lossless compression or higher bit width may be used to ensure high model/neural network accuracy is achieved. However, as the network conditions degrade, the methods may comprise increasing the compression ratio by choosing smaller bit widths.

The step of identifying a number of computing resources available to the user device may comprise: identifying computing resources within a local network containing the user device; identifying computing resources at an edge of the local network; identifying computing resources in a cloud server; and/or identifying computing resources within the electronic user device.

The identified computing resources within the electronic user device may comprise one or more of: a central processing unit (CPU), a graphics processing unit (GPU), a neural processing unit (NPU), and a digital signal processor (DSP).

The step of identifying a number of computing resources available to the user device may comprise: identifying computing resources that are a single hop from the user device. That is, there is no intermediate device between the user device and the identified computing resource, such that data transfers from the user device to the identified computing resource directly.

Alternatively, the step of identifying a number of computing resources available to the user device may comprise: identifying computing resources that are a single hop or multiple hops from the user device. That is, there may any number of intermediate devices between the user device and the identified computing resource. The multiple hop offloading may be implemented as multiple single hop offloadings. That is, for example, a user device may offload to an edge computing resource, and the edge computing resource may offload to a cloud computing resource. The term “offload” is used herein to mean distributing, from one device, some or all of the execution of a neural network to one or more other devices/computing resources.

The step of determining a subset of the identified computing resources may comprise: determining a first subset of resources that are a single hop from the user device and able to satisfy the at least one optimisation constraint, and a second subset of resources that are one or more hops from the first subset of resources and able to satisfy the at least one optimisation constraint; and wherein the step of partitioning a neural network into a number of partitions comprises: partitioning the neural network into a first set of partitions based on the determined first subset of computing resources and second subset of computing resources. In other words, the partitioning of the neural network computation into the first set of partitions may be performed based on the number of suitable computing resources that are a single hop from the user device. However, the amount of data in each partition may be determined by knowing how many computing resources are available to each of the suitable single hop computing resources, that is, how many resources from the second subset of computing resources are available/connected to each single hop computing resource. If, for example, a single hop computing resource is coupled to one or more other computing resources (which are multiple hops from the user device), the single hop computing resource may be assigned a larger partition of the neural network computation because the single hop computing resource could further offload/distribute part of the computation to the computing resources in the second subset to which it is connected. In other words, the present techniques enable multi-hop offloading to be performed. Thus, the user device may have a view of all the available hops in the system, whereas ordinarily, each device in a network is only aware of the next hop (i.e. one hop).

The method may further comprise: receiving, during execution of a partition by a first computing resource of the subset of computing resources, a message indicating that the first computing resource is unable to complete the execution. That is, the user device may discover that a computing resource that has been assigned a partition to execute can no longer complete the execution/computation because, for example, the computing resource is now scheduled or required to perform other functions or computations. For example, a games console may have been assigned a partition to execute because it was not performing any other processing (i.e. was not being used to play a game), but subsequent to the assigning, a person has started to use the games console. Accordingly, the load of the games console has changed. The method therefore, may dynamically change how the neural network is distributed based on new information. This may ensure that the neural network computation is completed quickly and efficiently, even when unexpected or unforeseen changes occur.

There are many ways the method may dynamically adapt or respond to changes at computing resource level. For example, the method may comprise determining whether the partition being executed by the first computing resource comprises an early exit point; obtaining a result from the early exit point; and terminating the execution of the partition. If an early exit point exits, the data or result obtainable at this early exit point may be sufficient to achieve the required neural network accuracy. For example, if the neural network accuracy is permitted to be less than 90%, using the data obtainable at an early exit point may enable the computation of the neural network to be completed and at an acceptable accuracy. However, if the neural network accuracy would fall below a permitted or required level, then the method may comprise reassigning the partition (or a remainder of the partition if some computation has already been performed) to a second computing resource from the subset of computing resources instead.

In some cases, instead of assigning each partition of the neural network to a single computing resource to be executed, the method may comprise assigning each partition of the neural network to be executed by a first computing resource and a second computing resource of the determined subset of computing resources. That is, the method may build-in redundancy into the distributed execution, in case one of the first and second computing resources suddenly is unable to complete the required computation/execution. In this case, when the user device receives, during execution of a partition by the first computing resource and the second resource, a message indicating that the first computing resource is unable to complete the execution, the user device may terminate the execution of the partition by the first resource. This is because the second computing resource can complete the execution. In some cases, both the first and second computing resources execute the partition of the neural network in parallel, and the result is taken from whichever computing resource completes the execution first/fastest. Thus, either the second computing resource is only used when the first computing resource fails (e.g. by detecting or determining failing resources at runtime with a ping mechanism or similar), or both computing resources are used to perform the same task at the same time. The technique used for a particular application or in a particular system may depend on the trade-off between the overall load and latency.

In a related approach of the present techniques, there is provided a non-transitory data carrier carrying processor control code to implement the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electro-magnetic, infrared, or semiconductor system, apparatus, or device, or any suitable combination of the foregoing.

Computer program code for carrying out operations of the present techniques may be written in any combination of one or more programming languages, including object oriented programming languages, functional programming languages, and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The above-mentioned features described with respect to the first approach also apply to the second and third approaches.

In a second approach of the present techniques, there is provided an electronic user device comprising: at least one processor coupled to memory and arranged to: receive instructions to execute a neural network; obtain at least one optimisation constraint to be satisfied when executing the neural network; identify a number of computing resources available to the user device, and a load of each computing resource; determine a subset of the identified computing resources that are able to satisfy the at least one optimisation constraint; partition the neural network into a number of partitions based on the determined subset of computing resources that are able to satisfy the at least one optimisation constraint; assign each partition of the neural network to be executed by one of the determined subset of computing resources; and schedule the execution of the partitions of the neural network by each computing resource assigned to execute a partition.

In a third approach of the present techniques, there is provided a system for distributing neural network execution, the system comprising: an electronic user device; and a plurality of computing resources; wherein the electronic user device comprises at least one processor coupled to memory and arranged to: receive instructions to execute a neural network; obtain at least one optimisation constraint to be satisfied when executing the neural network; identify, from the plurality of computing resources, a number of computing resources available to the user device, and a load of each computing resource; determine a subset of the identified computing resources that are able to satisfy the at least one optimisation constraint; partition the neural network into a number of partitions based on the determined subset of computing resources that are able to satisfy the at least one optimisation constraint; assign each partition of the neural network to be executed by one of the determined subset of computing resources; and schedule the execution of the partitions of the neural network by each computing resource assigned to execute a partition.

The system may further comprise a hub device arranged to communicate with the electronic user device and the plurality of computing resources, and to obtain information on a load of each computing resource. That is, the system may comprise a router that is based in an environment (e.g. a home or office) and is connected to each device or computing resource in that environment. The router/hub device may receive information or data from each device to which it is connected indicating, for example, device status, device load, device scheduling information, and device errors. This information may be used by the electronic user device to determine how to partition the neural network computation (or to dynamically repartition or reassign partitions if a computing resource is unable to compute a partition that it has been assigned). For example, if the hub device knows that a computing resource is in sleep mode at certain times of day, or is currently idle, or currently has a high load, the hub device can provide this information to the user device, as this enables appropriate computing resources to be selected to implement a neural network. The hub device may be used therefore, by the electronic user device, to identify a number of computing resources available to the user device. Data for each partition may be communicated by the user device to each computing resource directly, or via the hub device (e.g. when the user device is not directly connected to, or does not have the required access permissions to communicate with, a computing resource).

The hub device may: receive, during execution of a partition by a first computing resource of the subset of computing resources, a message indicating that the first computing resource is unable to complete the execution; and transmit the message to the user device. The user device may: determine whether the partition being executed by the first computing resource comprises an early exit point; obtain a result from the early exit point; and terminate the execution of the partition.

Alternatively, the hub device may: receive, during execution of a partition by a first computing resource of the subset of computing resources, a message indicating that the first computing resource is unable to complete the execution; and transmit the message to the user device. The user device may: reassign the partition to a second computing resource from the subset of computing resources.

### BRIEF DESCRIPTION OF DRAWINGS

Implementations of the present techniques will now be described, by way of example only, with reference to the accompanying drawings, in which:

FIG. 1 is a flowchart of example steps to distribute the execution or computation of a neural network;

FIG. 2 is a block diagram of a system distributing the execution of a neural network;

FIG. 3 illustrates computing resources in a local network of a user device for executing a neural network;

FIG. 4 illustrates computing resources within a user device for executing a neural network;

FIG. 5 illustrates multi-hop distribution of the execution of a neural network; and

FIG. 6 is a block diagram of a technique for distributing the execution of a neural network.

### MODE FOR THE INVENTION

Broadly speaking, the present techniques relate to methods and systems for dynamically distributing the execution of a neural network across multiple computing resources in order to satisfy various criteria associated with implementing the neural network. For example, the distribution may be performed to spread the processing load across multiple device, which may enable the neural network computation to be performed quicker than if performed by a single device and more cost-effectively than if the computation was performed entirely by a cloud server.

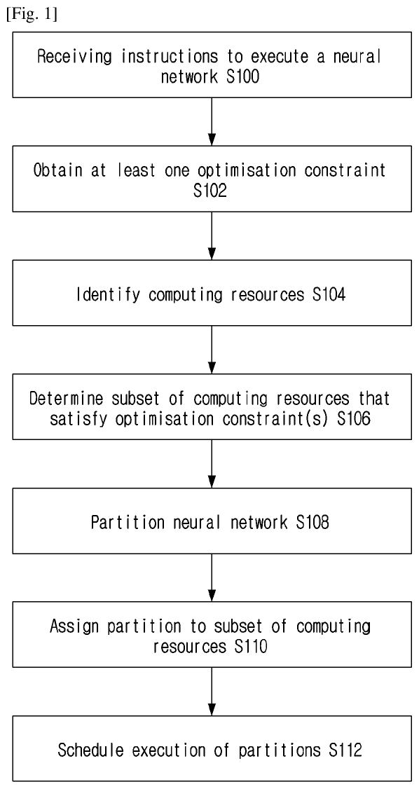

FIG. 1 is a flowchart of example steps to distribute the execution or computation of a neural network. The method may begin by receiving, on a user device, instructions to execute a neural network (step S100). The user device may be any electronic device, such as, but not limited to, a smartphone, tablet, laptop, computer or computing device, virtual assistant device, robot or robotic device, image capture system/device, AR system/device, VR system/device, gaming system, Internet of Things (IoT) device, a smart consumer device (e.g. a smart fridge), etc. The neural network may be implemented as part of a function of the user device.

The method may comprise obtaining at least one optimisation constraint to be satisfied when executing the neural network (step S102). This step may comprise obtaining one or more of: a time constraint (e.g. the neural network must take no longer than 1 ms to execute/output a result), a cost constraint (e.g. a fixed cost value, or specified in terms of how long a cloud server can be used for per device), inference throughput, data transfer size (e.g. the number of Mbytes or Gbytes of data that need to transferred to other computing resources to implement the neural network), energy constraint (which could be specified in terms of cost), and neural network accuracy (e.g. must always be 100%, or an accuracy of at least 80% is required).

The optimisation constraint may be specified by a service level agreement or a particular neural network or application area. Where multiple optimisation constraints are obtained, the optimisation constraints may be ranked or prioritised. For example, a time constraint may be ranked as more important when determining how to execute the neural network than neural network accuracy.

The time criterion may be an inference latency. For example, the time criterion may specify that the inference latency is less than 100 ms.

The cost criterion may comprise one or both of: a cost of implementing the neural network on the electronic user device, and a cost of implementing the neural network on a cloud server. The cost criterion may specify the maximum number of times (or number of seconds/minutes) per day, week or year that a user device can use a cloud server to implement part of a neural network. However, the cost per client for cloud usage may not be entirely representative of the cost to deploy a neural network—this means that the cost criterion may, in some cases, be a soft constraint that specifies that cloud usage is to be optimised among multiple different clients/user devices, rather than a hard constraint on each individual client/user device (which could result in cloud resources being underutilised). Thus, the cost criterion may specify how often the cloud server may be used and indirectly specify a cost or maximum cost requirement.

At step S104, the method may comprise identifying a number of computing resources available to the user device, and a load of each computing resource. That is, the method may identify computing resources that a user device may be able to communicate with (e.g. send data to and receive data from) and which may be able to help perform the required neural network computation. The execution of the neural network may be distributed between the user device and at least one computing resource in the same network as the user device (e.g. in a home, vehicle or office environment), and/or between the user device and at least one computing resource at the edge of the network containing the user device, and/or between the user device and at least one computing resource in the cloud/a cloud server. It will be understood that the computing resources could be based anywhere, and that multiple computing resources of different types or in different locations could be used.

The method may comprise determining a subset of the identified computing resources that are able to satisfy the at least one optimisation constraint (step S106). In other words, the method may comprise filtering and selecting a subset of computing resources from the identified computing resources which, if used to implement part of the neural network computation, would enable the optimisation constraints to be satisfied. For example, the method may not select a computing resource even if it has suitable processing power because it is scheduled to perform other processing at the same time as when the neural network is to be executed, or because the bandwidth of the communication channel used to send data to the computing resource is too low and would cause the execution of the neural network to take too long.

Once the subset of computing resources which satisfy the optimisation constraints has been identified, the method may comprise partitioning the neural network into a number of partitions based on the determined subset of computing resources that are able to satisfy the at least one optimisation constraint (step S108). For example, if two computing resources are identified, the method may divide the neural network into three partitions—one to be implemented by the user device, and two to be implemented by the two computing resources. In another example, if two computing resources are identified, the method may divide the neural network into two partitions, one to be implemented by each of the computing resources, while the user device does not implement any partition.

The partitions may be of equal or unequal sizes. As explained more below, in some cases, a computing resource may itself be able to share part of the computation of a partition of the neural network with a further computing resource. In such cases, the partition may factor this further subdivision/further distribution into account when distributing the computation across the identified subset of computing resources. The partitions may also be determined based on the computing capability/processing power of a computing resource, the load of the computing resource, and the speed of data transmission to/from the computing resource, for example.

The method may comprise assigning each partition of the neural network to be executed by one of the determined subset of computing resources (step S110), and scheduling the execution of the partitions of the neural network by each computing resource assigned to execute a partition (step S112). In some cases, the execution of two or more partitions may take place in parallel or substantially in parallel. In other cases, the execution of one partition may require another partition to have completed or partly completed. Therefore, whichever way the neural network is divided, the execution of the partitions is scheduled to ensure the neural network can be computed in a time and resource efficient manner.

The method may further comprise: receiving, during execution of a partition by a first computing resource of the subset of computing resources, a message indicating that the first computing resource is unable to complete the execution. That is, the user device may discover that a computing resource that has been assigned a partition to execute can no longer complete the execution/computation because, for example, the computing resource is now scheduled or required to perform other functions or computations. For example, a games console may have been assigned a partition to execute because it was not performing any other processing (i.e. was not being used to play a game), but subsequent to the assigning, a person has started to use the games console. Accordingly, the load of the games console has changed. The method therefore, may dynamically change how the neural network is distributed based on new information. This may ensure that the neural network computation is completed quickly and efficiently, even when unexpected or unforeseen changes occur.

There are many ways the method may dynamically adapt or respond to changes at computing resource level. For example, the method may comprise determining whether the partition being executed by the first computing resource comprises an early exit point; obtaining a result from the early exit point; and terminating the execution of the partition. If an early exit point exits, the data or result obtainable at this early exit point may be sufficient to achieve the required neural network accuracy. For example, if the neural network accuracy is permitted to be less than 90%, using the data obtainable at an early exit point may enable the computation of the neural network to be completed and at an acceptable accuracy. However, if the neural network accuracy would fall below a permitted or required level, then the method may comprise reassigning the partition (or a remainder of the partition if some computation has already been performed) to a second computing resource from the subset of computing resources instead.

In some cases, instead of assigning each partition of the neural network to a single computing resource to be executed, the method may comprise assigning each partition of the neural network to be executed by a first computing resource and a second computing resource of the determined subset of computing resources. (This may be performed in advance rather than during a failure recognition and deployment setting/function, so that the second computing resource is already identified at the outset). That is, the method may build-in redundancy into the distributed execution, in case one of the first and second computing resources suddenly is unable to complete the required computation/execution. In this case, when the user device receives, during execution of a partition by the first computing resource and the second resource, a message indicating that the first computing resource is unable to complete the execution, the user device may terminate the execution of the partition by the first resource. This is because the second computing resource can complete the execution.

In some cases, both the first and second computing resources may execute the partition of the neural network in parallel, and the result is taken from whichever computing resource completes the execution first/fastest. Thus, either the second computing resource is only used when the first computing resource fails (e.g. by detecting or determining failing resources at runtime with a ping mechanism or similar), or both computing resources are used to perform the same task at the same time. The technique used for a particular application or in a particular system may depend on the trade-off between the overall load and latency.

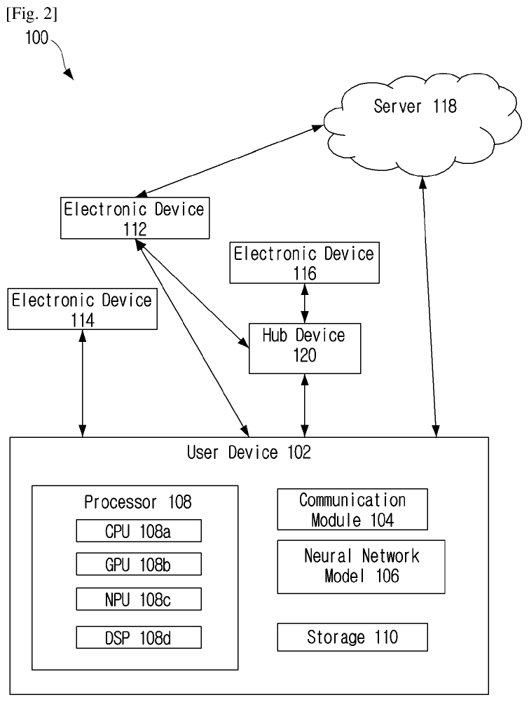

FIG. 2 is a block diagram of a system 100 distributing the execution of a neural network. The system comprises at least one electronic user device 102. For the sake of simplicity, only one user device 102 is shown in FIG. 2. The electronic user device 102 may be any user device, such as, but not limited to, a smartphone, tablet, laptop, computer or computing device, virtual assistant device, robot or robotic device, consumer good/appliance (e.g. a smart fridge), an internet of things device, or image capture system/device.

The user device 102 may comprise a communication module 104 to enable the user device to communicate with other devices/machines/components of the system 100. The communication module 104 may be any communication module suitable for sending and receiving data. The communication module may communicate with other machines in system 100 using any one or more of: wireless communication (e.g. WiFi), hypertext transfer protocol (HTTP), message queuing telemetry transport (MQTT), a wireless mobile telecommunication protocol, short range communication such as radio frequency communication (RFID) or near field communication (NFC), or by using the communication protocols specified by ZigBee, Thread, Bluetooth, Bluetooth LE, IPv6 over Low Power Wireless Standard (6LoWPAN), Constrained Application Protocol (CoAP), wired communication. The communication module 104 may use a wireless mobile (cellular) telecommunication protocol to communicate with machines in the system, e.g. 3G, 4G, 5G, 6G etc. The communication module 104 may communicate with machines in the system 100 using wired communication techniques, such as via metal cables or fibre optic cables. The user device 102 may use more than one communication technique to communicate with other components in the system 100. It will be understood that this is a non-exhaustive list of communication techniques that the communication module 104 may use. It will also be understood that intermediary devices (such as a gateway) may be located between the user device 102 and other components in the system 100, to facilitate communication between the machines/components.

The user device 102 may comprise storage 110. Storage 110 may comprise a volatile memory, such as random access memory (RAM), for use as temporary memory, and/or non-volatile memory such as Flash, read only memory (ROM), or electrically erasable programmable ROM (EEPROM), for storing data, programs, or instructions, for example.

User device 102 may comprise one or more interfaces (not shown) that enable the device to receive inputs and/or generate outputs (e.g. audio and/or visual inputs and outputs, or control commands, etc.) For example, the user device 102 may comprise a display screen to show the results of implementing a neural network.

The user device 102 comprises at least one processor or processing circuitry 108. The processor 108 controls various processing operations performed by the user device 102, such as communication with other components in system 100, and distributing all or part of the computation of a machine learning/neural network model from the device 102 to other computing resources in system 100. The processor may comprise processing logic to process data and generate output data/messages in response to the processing. The processor may comprise one or more of: a microprocessor, a microcontroller, and an integrated circuit.

The processor 108 may itself comprise computing resources that are available to the user device 102 for executing a neural network. That is, the electronic user device 102 may comprise one or more of: a central processing unit (CPU) 108a, a graphics processing unit (GPU) 108b, a neural processing unit (NPU) 108c, and/or a digital signal processor (DSP) 108d. Any of these computing resources may be used by the user device 102 to execute part of the neural network.

The user device 102 comprises a machine learning model or neural network model 106.

Thus, the electronic user device 102 comprises: at least one processor 108 coupled to memory 110 and arranged to: receive instructions to execute a neural network; obtain at least one optimisation constraint to be satisfied when executing the neural network; identify a number of computing resources available to the user device, and a load of each computing resource; determine a subset of the identified computing resources that are able to satisfy the at least one optimisation constraint; partition the neural network into a number of partitions based on the determined subset of computing resources that are able to satisfy the at least one optimisation constraint; assign each partition of the neural network to be executed by one of the determined subset of computing resources; and schedule the execution of the partitions of the neural network by each computing resource assigned to execute a partition.

System 100 comprises a plurality of computing resources. As mentioned above, the computing resources may be local to the user device 102 (e.g. in the vicinity of or in the same network as the user device 102). For example, the system 100 may comprise electronic devices 112, 114, 116 which are in the local network of the user device 102. The electronic devices 112, 114, 116 may be any sort of electronic device, such as a laptop, a smart television, an IoT device, a gaming system, etc. The user device 102 may be able to communicate with the electronic devices directly, or indirectly. For example, the system 100 may comprise a hub device 120 arranged to communicate with the electronic user device 102 and the plurality of computing resources 112, 116 and to obtain information on a load of each computing resource 112, 116. That is, the system 100 may comprise a router 120 that is based in an environment (e.g. a home or office) and is connected to each device or computing resource in that environment. The router/hub device 120 may receive information or data from each device to which it is connected indicating, for example, device status, device load, device scheduling information, and device errors. This information may be used by the electronic user device 102 to determine how to partition the neural network computation (or to dynamically repartition or reassign partitions if a computing resource is unable to compute a partition that it has been assigned). For example, if the hub device 120 knows that a computing resource is in sleep mode at certain times of day, or is currently idle, or currently has a high load, the hub device can provide this information to the user device, as this enables appropriate computing resources to be selected to implement a neural network. The hub device 120 may be used therefore, by the electronic user device 102, to identify a number of computing resources available to the user device 102. Data for each partition may be communicated by the user device 102 to each computing resource 112, 116 directly, or via the hub device 120 (e.g. when the user device is not directly connected to, or does not have the required access permissions to communicate with, a computing resource).

One of the computing resources in system 100 may be a server 118. The server 118 may be a remote or cloud server which is not in the local network of user device 102, but is available to the user device 102 to implement part of a neural network. As explained earlier, it is desirable to limit the amount of processing performed by server 118, for cost effectiveness. However, in some cases, the required speed of execution or the lack of other available computing resources may mean that some of the neural network needs to be processed by the server 118. The user device 102 may communicate directly with the server 118 or via an intermediate device, e.g. via hub device 120.

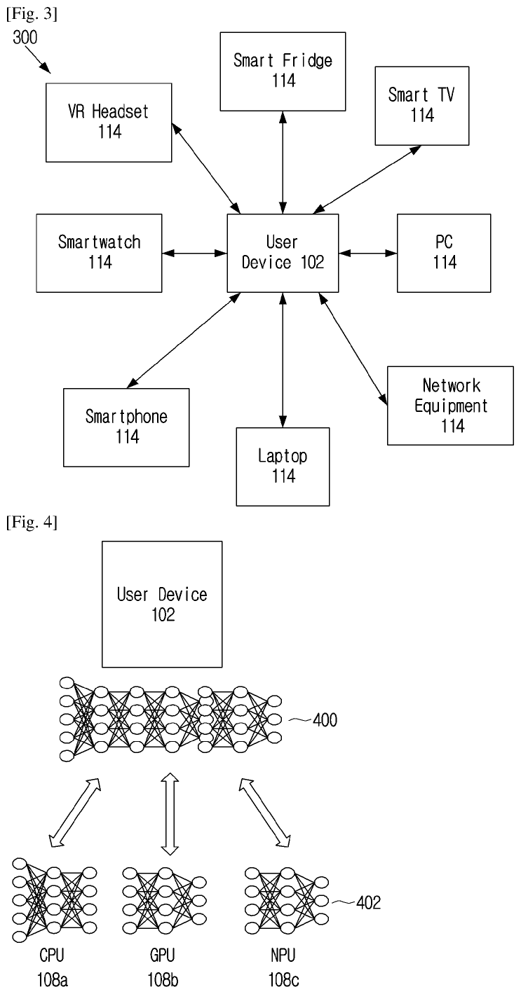

FIG. 3 illustrates computing resources in a local network 300 of a user device 102 for executing a neural network. The computing resources 114 may be any suitable computing resource/device, such as, but not limited to, a smart fridge, smart television, computer/laptop/PC, network equipment, a portable or mobile computing device, a smartphone, a wearable device such as a smartwatch, and a VR or AR headset. Offloading some or all of the computation of a neural network from user device 102 to one or more computing resources inside the local network 300 may save energy and time, as spare/available resources located close to the user device 102 are being used. Thus, the step of identifying a number of computing resources available to the user device (step S104 in FIG. 1) may comprise identifying computing resources within a local network containing the user device 102.

The step of identifying a number of computing resources available to the user device (step S104 in FIG. 1) may comprise identifying computing resources at an edge of the local network and/or identifying computing resources in a cloud server. Thus, a user device 102 may collaborate with edge or cloud computing resources to speed up computation, enable new AI applications to be implemented, and to save energy. Cost savings may be achieved by performing some computation on the user device 102 (and/or on a computing resource in the local network of the user device 102), and reducing the amount performed by the cloud. In some scenarios, it may be useful to use resources at the edge or in the cloud. For example, if the user device 102 is able to implement the neural network itself, the cloud/edge resources do not need to be used. If the user device 102 is able to implement say, 70% of the neural network computation to meet any criteria, assistance from cloud or edge resources may be used to perform the remaining 30%, and data may be transmitted using a mobile network such as 5G (as there is relatively little data to be sent/received). If the user device is only able to perform 40% of the computation, the cloud/edge resources may be used to perform the remaining 60%, and data may be transmitted using wireless communication techniques such as WiFi (as there is more data to be sent/received).

FIG. 4 illustrates computing resources within a user device 102 for executing a neural network. The step of identifying a number of computing resources available to the user device may comprise: identifying computing resources within the electronic user device 102. As mentioned above, the user device 102 may one or more of: a central processing unit (CPU) 108a, a graphics processing unit (GPU) 108b, a neural processing unit (NPU) 108c, and/or a digital signal processor (DSP) 108d. Any of these computing resources may be used by the user device 102 to execute part of the neural network. Thus, the neural network execution 400 may be distributed across multiple computing resources within the user device 102. Each computing resource within the user device may receive a partition 402 of the neural network to execute.

Thus, a neural network model may be split and run on a CPU (full precision), GPU (half-precision), NPU (low precision), and/or a DSP (low precision), while at the same time maximising parallel execution. The scheduling step (step S112 in FIG. 1) may comprise scheduling and pipelining the execution of the partitions 402 in a way that each partition takes a similar time to execute, thus maximising throughput.

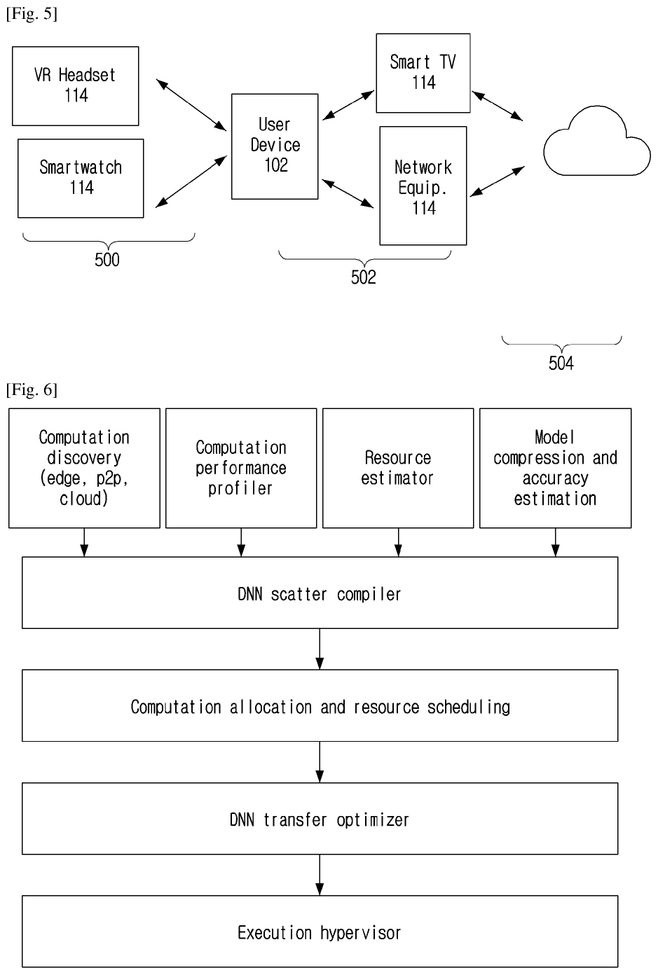

FIG. 5 illustrates multi-hop distribution of the execution of a neural network. The step of identifying a number of computing resources available to the user device may comprise: identifying computing resources 500 that are a single hop from the user device 102. That is, there is no intermediate device between the user device 102 and the identified computing resources 500, such that data transfers from the user device 102 to the identified computing resources 500 directly.

Alternatively, the step of identifying a number of computing resources available to the user device may comprise: identifying computing resources that are a single hop or multiple hops from the user device. That is, there may any number of intermediate devices between the user device and the identified computing resource. In FIG. 5, devices 502 are a single hop away from the user device 102. Device 504 is a single hop from devices 502, but two hops from user device 102.

The step of determining a subset of the identified computing resources may comprise: determining a first subset of resources 500, 502 that are a single hop from the user device 102 and able to satisfy the at least one optimisation constraint, and a second subset of resources 504 that are one or more hops from the first subset of resources 502 and able to satisfy the at least one optimisation constraint. The step of partitioning a neural network into a number of partitions may comprise: partitioning the neural network into a first set of partitions based on the determined first subset of computing resources 500, 502 and second subset of computing resources 504. In other words, the partitioning of the neural network computation into the first set of partitions may be performed based on the number of suitable computing resources 500, 502 that are a single hop from the user device. However, the amount of data in each partition may be determined by knowing how many computing resources are available to each of the suitable single hop computing resources, that is, how many resources from the second subset of computing resources 504 are available/connected to each single hop computing resource 502. If, for example, a single hop computing resource 502 is coupled to one or more other computing resources 504 (which are multiple hops from the user device 102), the single hop computing resource 502 may be assigned a larger partition of the neural network computation because the single hop computing resource could further offload/distribute part of the computation to the computing resources 504 in the second subset to which it is connected. In other words, the present techniques enable multi-hop offloading to be performed.

Multi-hop offloading of the neural network computation may be useful because benefits may be achieved at different scales. This technique may be used in cases where a latency criterion and a throughput criterion exist. The offloading could be performed from the user device 102 to an edge resource, and then from the edge resource to a cloud server, for example.

FIG. 6 is a block diagram of a scheduler for distributing the execution of a neural network. The execution scheduler or DNN scatter compiler may use profile and runtime data from the user device, network, cloud and DNN metrics to dynamically distribute computation of the neural network to available and suitable computing resources in order to meet any application requirements (e.g. criteria associated with running the neural network).

As mentioned above, the present techniques may split a network in multiple arbitrary partitions and assign those into different instances to be run. A deep neural network (DNN) may be represented by a Directed Acyclic Graph (DAG), called a dependency or execution graph of a network. Such a graph can be represented as G=(V, E), where V is the set of modules and E represents the data dependencies. Despite the various branches and skip connections in modern DNN architectures, their computation can be run sequentially. The size of the tensors manipulated by DNN layers can vary greatly with many reaching several hundred kilobytes. Transferring one or more of these tensors can quickly outweigh the benefits of distributing the execution of the DNN, particularly under poor network conditions.

Once an execution graph has been constructed, and the dependencies for each possible cut point s have been determined, the present techniques need to determine how to partition the network and how much compression c to apply on the transferred dependencies. These decisions impact the inference latency, throughput, accuracy and cost of implementation. The user device 102 may make the decisions by estimating the device, network and cloud computing times, as well as any possible accuracy loss due to excessive compression, for each possible scenario <s, c>. With respect to FIG. 6, for a given cut s and compression c, the profiler needs to supply the scheduler with an estimated timing information. The computation performance profiler may keep track of the times required to perform the corresponding DNN operations by each computing resource.

The dynamic scheduler or DNN scatter compiler may discover resources and decide how to distribute the DNN computation across the resources so as to satisfy application requirements. The dynamic aspect is particularly important for mobile devices where connectivity and load conditions can rapidly change (e.g. when a mobile device moves from being connected to WiFi, to be connected to 3G).

The DNN transfer optimiser may reduce communication costs by up to 60 times, by compressing data when necessary. For example, the DNN transfer optimiser may apply varying levels of lossless or lossy compression techniques to the data to be transferred to a computing resource for execution/computation. When lossy compression is applied, the present techniques may take advantage of the nature of the data that is needed to be transferred to the other computing resources. (e.g. intermediate layer outputs) to reduce the data down to a point where the neural network accuracy is not compromised by the compression.

Thus, the method may further comprise identifying a communication channel type for transferring data to each computing resource assigned to execute a partition; and determining whether communication channel based optimisation is required to transfer data to each computing resource for executing the partition. In other words, the method may identify what sort of communication protocol or channel (e.g. WiFi, Bluetooth, Thread, IPv6 over Low Power Wireless Standard (6LoWPAN), ZigBee, etc.) is used to communicate or send data between the user device and each computing resource, and use this information to determine if any data transfer optimisation process is required to transfer data to the computing resource for executing the neural network.

When communication channel based optimisation is required for a computing resource, the method may further comprise: compressing data to be transferred to the computing resource prior to transmitting the data to the computing resource for executing the partition, and/or quantising data to be transferred to the computing resource prior to transmitting the data to the computing resource for executing the partition. In cases where both compression and tensor quantisation are used, the quantisation may be performed prior to the compression.

In some cases, the method may comprise using any one or more of the following techniques: tensor quantisation, bit shuffling, and compression.

Tensor quantisation is frequently used in DNNs to reduce the model size and speed-up its operation. Linear quantisation may be performed on the intermediate activations that have to be transferred between the partitions. For example, 32 bit floats may be reduced into lower bit width representations such as 4 bits. In some cases, only the transferred tensors are quantized, and the weights and remaining activations of the model operate at their original bit width (e.g. 32 bits). Tensor quantisation may not be used in cases when lossless compression is used.

Bit shuffling comprises transposing the matrix such that all the least-significant-bits are in the same row. This data rearranging may allow the elimination of the computationally expensive Huffman coding in favour of a faster lossless data compression technique (such as LZ77 or LZ4).

Compression may comprise applying a fast lossless compression algorithm. When combined with tensor quantisation and bit shuffling, a significant reduction in data entropy may result, such that the resulting data size may be 60 times smaller than the size of the original tensors.

When the compressed data is sent to a computing resource for processing/execution, the computing resource reverses the techniques used to compress the data so that the data is returned to its original bit width before being used in the neural network.

The amount of compression applied by the present techniques is configurable. If the network conditions are good enough to meet a time criterion, lossless compression or higher bit widths may be used to ensure high model/neural network accuracy is achieved. However, as the network conditions degrade, the methods may comprise increasing the compression ratio by choosing smaller bit widths.

The execution hypervisor may ensure that any application criterion (e.g. service level agreements) are satisfied and new computation is migrated appropriately.

An example use of the distributed neural network execution is in robotic assistant devices. Robot assistants may need to run multiple real-time AI models simultaneously with minimal or restricted power requirements. Such devices may be able to use the present techniques to offload latency-critical models to their charging station—the charging station may comprise a GPU that can be used to help implement a model. Such devices may also be able to offload more challenging or computationally-intensive models to the cloud. Other models may be scattered/distributed among devices in the robot device's local network.

Another example use of the present techniques is in augmented reality (AR) glasses. AR glasses may be used by spectators in a stadium watching a football game. The AR glasses may be used to annotate the spectator's view of the game with relevant information, e.g. player information, statistics, etc. The AR glasses may use the present techniques to offload information to the local edge—in this case, the local edge may be located within the football stadium. Data transfer may take place over 5G. The part of the model running on the local edge may have an extra input layer for receiving real-time local information (e.g. game statistics). Thus, the user-model (AR glasses model) may be fused with the edge model to provide an enhanced AR experience to the spectators.

Telepresence is a model where multiple users may be part of a single model that renders them in a virtual world. The present techniques may allow the model to be split amongst the user devices. For example, the model may be split into three partitions. Each user device may run one part of the model, with separate inputs for video and audio. A second part of the model may be implemented in the cloud and merged with other information to generate the virtual environment/world. The third part of the model may be run on each user device to perform upscaling and video generation.

In a smart home environment, all smart or connected devices in the home may be part of a single model that has access to all the information collected from different modalities and locations within the home. This may improve accuracy and increase the number of AI applications that could be implemented in a home. Each device may run a part of the model, and the model may be merged at a single device (e.g. a hub device), where the embeddings are all merged, and a single model output is generated.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A method for distributing neural network execution using an electronic user device, the method comprising:
receiving instructions to execute a neural network;
obtaining at least one optimisation constraint to be satisfied when executing the neural network;
identifying a number of computing resources available to the user device, and a load of each computing resource;
determining a subset of the identified computing resources that are able to satisfy the at least one optimisation constraint;
partitioning the neural network into a number of partitions based on the determined subset of computing resources that are able to satisfy the at least one optimisation constraint;
assigning each partition of the neural network to be executed by one of the determined subset of computing resources; and
scheduling the execution of the partitions of the neural network by each computing resource assigned to execute a partition.

2. The method as claimed in claim 1 wherein the step of obtaining at least one optimisation constraint comprises obtaining one or more of: a time constraint, a cost constraint, inference throughput, data transfer size, an energy constraint, and neural network accuracy.

3. The method as claimed in claim 2 wherein the time criterion is an inference latency.

4. The method as claimed in claim 2 wherein the cost criterion comprises one or both of: a cost of implementing the neural network on the electronic user device, and a cost of implementing the neural network on a cloud server.

5. The method as claimed in claim 1 wherein the step of obtaining at least one criterion comprise obtaining the at least one criterion from a service-level agreement associated with executing the neural network.

6. The method as claimed in claim 1 further comprising:
identifying a communication channel type for transferring data to each computing resource assigned to execute a partition; and
determining whether communication channel based optimisation is required to transfer data to each computing resource for executing the partition.

7. The method as claimed in claim 6 wherein when communication channel based optimisation is required for a computing resource, the method further comprises:
compressing data to be transferred to the computing resource prior to transmitting the data to the computing resource for executing the partition.

8. The method as claimed in claim 6 wherein when communication channel based optimisation is required for a computing resource, the method further comprises:
quantising data to be transferred to the computing resource prior to transmitting the data to the computing resource for executing the partition.

9. The method as claimed in claim 1 wherein the step of identifying a number of computing resources available to the user device comprises:
identifying computing resources within a local network containing the user device;
identifying computing resources at an edge of the local network;
identifying computing resources in a cloud server; and
identifying computing resources within the electronic user device.

10. The method as claimed in claim 9 wherein the identified computing resources within the electronic user device comprise one or more of: a central processing unit, a graphics processing unit, a neural processing unit, and a digital signal processor.

11. The method as claimed in claim 1 wherein the step of identifying a number of computing resources available to the user device comprises:
identifying computing resources that are a single hop from the user device.

12. The method as claimed in claim 1 wherein the step of identifying a number of computing resources available to the user device comprises:
identifying computing resources that are a single hop or multiple hops from the user device.

13. The method as claimed in claim 12 wherein the step of determining a subset of the identified computing resources comprises:
determining a first subset of resources that are a single hop from the user device and able to satisfy the at least one optimisation constraint, and a second subset of resources that are one or more hops from the first subset of resources and able to satisfy the at least one optimisation constraint; and
wherein the step of partitioning a neural network into a number of partitions comprises:
partitioning the neural network into a first set of partitions based on the determined first subset of computing resources and second subset of computing resources.

14. The method as claimed in claim 1 further comprising:
receiving, during execution of a partition by a first computing resource of the subset of computing resources, a message indicating that the first computing resource is unable to complete the execution.

15. An electronic user device comprising:
at least one processor coupled to memory and arranged to:
receive instructions to execute a neural network;
obtain at least one optimisation constraint to be satisfied when executing the neural network;
identify a number of computing resources available to the user device, and a load of each computing resource;
determine a subset of the identified computing resources that are able to satisfy the at least one optimisation constraint;
partition the neural network into a number of partitions based on the determined subset of computing resources that are able to satisfy the at least one optimisation constraint;
assign each partition of the neural network to be executed by one of the determined subset of computing resources; and
schedule the execution of the partitions of the neural network by each computing resource assigned to execute a partition.
